(19) United States
(12) Patent Application Publication
(10) Pub. No.: US 2012/0102159 A1
(43) Pub. Date: Apr. 26, 2012

(54) RESOURCE CONFLICT AVOIDANCE SYSTEM AND METHOD

(75) Inventor: TAN-KE LUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/205,643

(22) Filed: Aug. 9, 2011

(30) Foreign Application Priority Data
Oct. 25, 2010 (CN) 201010517913.2

(51) Int. Cl. G06F 15/16

(52) U.S. Cl. 709/220

(57) ABSTRACT

A diskless workstation and method avoids resource conflict when the diskless workstation is booted by a server. The diskless workstation downloads a boot program, a kernel, an image file and a configuration file from a server to a memory of the diskless workstation. The kernel is stated and a temporary file directory is created in the memory. The created temporary file directory is mounted to a default temporary file directory of the root directory. A subdirectory in the created temporary directory is created and a record file in the subdirectory is created for recording information during the running of the operating system.

### BACKGROUND

1. Technical Field

Embodiments of the present disclosure relate to file processing technology, and particularly to a resource conflict avoidance system and method.

2. Description of Related Art

Network booting of a computer workstation or node is a process of booting a computer from a network rather than a local drive. A diskless workstation (e.g., a thin client) or a diskless node is booted via the network booting. Diskless workstations use their own hardware (e.g., CPU and memory) to process data, but do not store data permanently. The storing of the permanent data is handed off to a remote server. However, in some situations, a resource conflict happens among two or more diskless workstations. For example, if diskless workstations A and B turn on at the same time, then A and B would invoke the same file system of an operating system from the remote server.

### BRIEF DESCRIPTION OF THE DRAWINGS

FIG. 1 is a system view of one embodiment of a resource conflict avoidance system.

FIG. 2 is a block diagram of one embodiment of a diskless workstation of FIG. 1.

FIG. 3 is a flowchart of one embodiment of a resource conflict avoidance method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

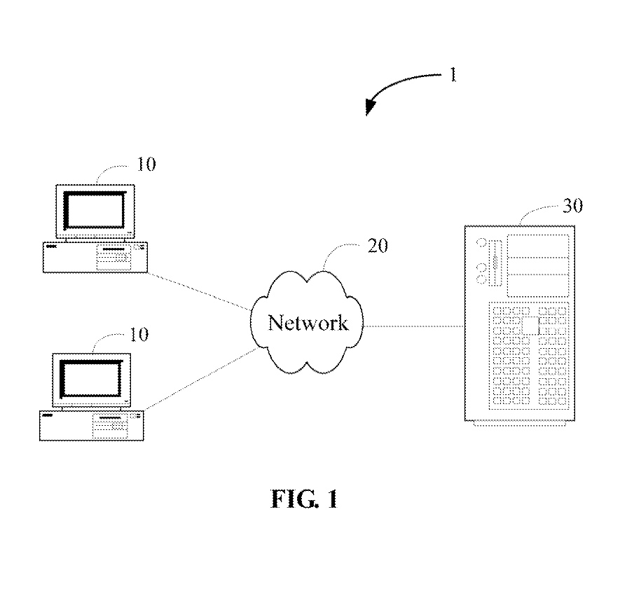

FIG. 1 is a system view of one embodiment of a resource conflict avoidance system 1. In one embodiment, the resource conflict avoidance system 1 may include one or more diskless workstations 10, a network 20, and a server 30. The resource conflict avoidance system 1 may be used to avoid resource conflict when the diskless workstations 10 are turned on. It is understood that the term “resource conflict” is defined as a situation that two and more diskless workstation invokes a file system of the server 30 at the same time. In the exemplary embodiment, the server 30, and the one or more diskless workstations 10 are connected to the network 20. The network 20 may be, but is not limited to, a wide area network (e.g., the Internet) or a local area network.

Each diskless workstation 10 employs network booting to load an operating system from the server 30 to a memory 14 of the diskless workstation 10. In one embodiment, each diskless workstation 10 maybe a workstation or a personal computer without disk drives. Additionally, each diskless workstation 10 provides a user interface on a display for a user to control one or more operations of the diskless workstation 10. Further details of the diskless workstations 10 will be described below.

The server 30, in one example, can be a dynamic host configuration protocol (DHCP) server. In one embodiment, the DHCP server 30 assigns IP addresses to the diskless workstations 10. The DHCP server 30 may provide three modes for allocating IP addresses to the diskless workstations 10. The modes are dynamic allocation, automatic allocation, and static allocation. In one embodiment, the DHCP server 30 uses dynamic allocation to assign the IP addresses to the diskless workstations 10. For example, when the DHCP server 30 receives a request from a diskless workstation 10 via the network 20, the DHCP server 30 dynamically assigns an IP address, and offers the diskless workstation 10 with the IP address. Additionally, the DHCP server 30 may be a personal computer (PC), a network server, or any other data-processing equipment.

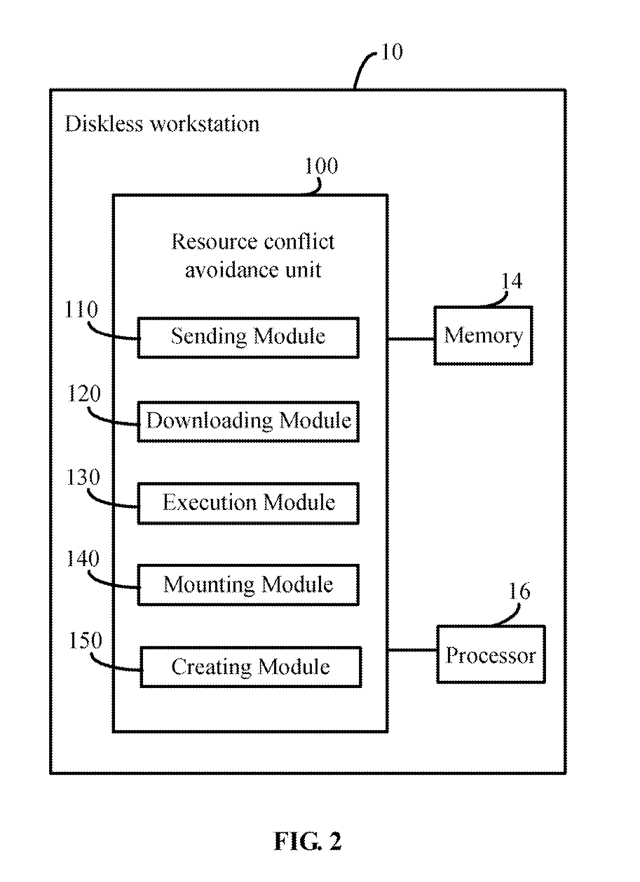

FIG. 2 is a block diagram of one embodiment of the diskless workstation 10 including a resource conflict avoidance unit 100. The resource conflict avoidance unit 100 may be used to automatically avoid resource conflict among the diskless workstations 10. In one embodiment, the diskless workstation 10 includes a memory 14, and at least one processor 16. In one embodiment, the resource conflict avoidance unit 100 includes a sending module 110, a downloading module 120, an execution module 130, a mounting module 140, and a creating module 150. The modules 110-150 may include computerized code in the form of one or more programs that are stored in the memory 14. The computerized code includes instructions that are executed by the at least one processor 16 to provide functions for the modules 110-150. The memory 14 may be an EPROM or flash.

The sending module 110 sends broadcasting packets to communicate with the server 30. In one embodiment, the broadcasting packets include an IP address assigned to the diskless workstation 30 by the server 30.

The downloading module 120 downloads a boot program, a kernel, an image file, and a configuration file of the operating system from the server 30 to the memory 14 of the diskless workstation 10. In one embodiment, the operating system may be, but is not limited to, a LINUX operating system. The boot program may be, but is not limited to, a boot loader of the LINUX operating system. The image file is an initrd file of the LINUX operating system. The configuration file includes a name of the kernel, a position of the kernel, a name of the image file, a position of the image file and parameters for starting the kernel, such as, IP address configurations, starting modes and hot-plugging device configurations.

The execution module 130 executes the boot program to start the kernel according to the image file and the configuration file and creates a temporary file directory in the memory 14 of the diskless workstation 10. In one embodiment, the execution module 130 executes the boot loader to invoke the configuration file and an init file of the intrid file to start the kernel. In one embodiment, the name of the temporary file directory may be “var”. It is understood that the temporary file directory is defined as a directory in the memory 14 for temporarily storing a file system of the operating system.

The mounting module 140 mounts a file system of the operating system in the server 30 to a root directory of the operating system and mounts the created temporary file directory to a default temporary file directory of the root directory. The file system is an integral part of the operating system. The root directory is the first and top-most directory in a hierarchy of the operating system. It is understood that the default temporary file directory is a subdirectory of the root directory and is used for temporarily storing files (e.g., log files) during the running of the operating system.

The execution module 150 further switches a permission to operate the diskless workstation 10 from a kernel layer to a user layer. In one embodiment, the kernel layer, which takes care of the communication with the hardware (e.g., memory, CPU), is the most low-level layer in the operating system. The user layer, in which a user can directly operate the operating system, is the top-level layer in the operating system. For example, a user interface is provided for the user to operate the operating system in the user layer.

The creating module 150 creates a subdirectory in the created temporary directory and a record file in the subdirectory for recording information generated during the running of the operating system. The information includes a log (e.g., time, date, error information) of the operating system.

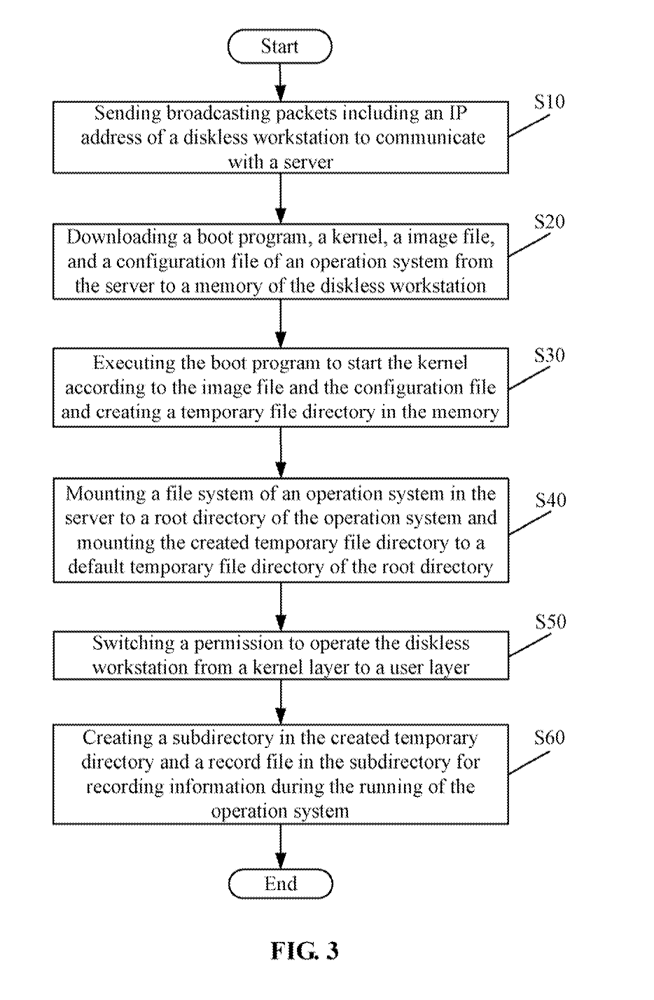

FIG. 3 is a flowchart of one embodiment of a resource conflict avoidance method. Depending on the embodiment, additional blocks may be added, others deleted, and the ordering of the blocks may be changed.

In block S10, the sending module 110 sends broadcasting packets to communicate with the server 30. As mentioned above, the broadcasting packets include an IP address assigned to the diskless workstation 30 by the server 30. In one embodiment, the server 30 receives the broadcasting packets and determines if the IP address of the broadcasting packets is valid. The server 30 sends a feedback to the diskless workstation 10 in response to a determination that the IP address is valid. The diskless workstation 10 can communicate and exchange data with the server 30 upon the condition that the diskless workstation 10 receives the feedback. The feedback may be a string, such as “ok!.”

In block S20, the downloading module 120 downloads a boot program, a kernel, an image file, and a configuration file of an operating system from the server 30 to the memory 14 of the diskless workstation 10. As mentioned above, the boot program may be, but is not limited to, a boot loader of the LINUX operating system. The image file is an initrd file of the LINUX operating system. The configuration file includes a name of the kernel, a position of the kernel, a name of the image file, a position of the image file and parameters for starting the kernel, such as, IP address configurations, starting modes and hot-plugging device configurations.

In block S30, the execution module 130 executes the boot program to start the kernel according to the image file and the configuration file and creates a temporary file directory in the memory 14 of the diskless workstation 10. In one embodiment, the execution module 130 executes the boot loader to invoke the configuration file and an init file of the intrid file to start the kernel. In one embodiment, the execution module 130 creates the temporary file directory as in one example follows: mkdir -p /var, wherein the “mkdir” is a command for creating the directory and the “var” is the name of the temporary file directory. It is understood that the temporary file directory “var” is defined as a directory in the memory 14 for temporarily storing a file system of the operating system.

In block S40, the mounting module 140 mounts the file system of the operating system in the server 30 to a root directory of the operating system and mounts the created temporary file directory to a default temporary file directory of the root directory.

The mounting module 140 mounts a file system of the operating system in the server 30 to a root directory of the operating system as in one example follows: mount -n -tmpfs 192.168.49.1:/tftpboot/pxeboot/sysroot, where the “mount” is the command, the “tempfs” (temporary file storage facility) is the file system, the “192.168.49.1” is the IP address of the serve 30, and the “sysroot” is the root directory of the operating system.

The mounting module 140 mounts the created temporary file directory to a default temporary file directory of the root directory as in one example follows: mount -n -o mode=0755, size=64m, rw -t tmpfs/var/sysroot/var, where the “mount” is the command, the “0755” is a mode when the file system is running, the “size=64 m” is the size of the file system, the “rw” is readable and writable when the file system is running.

In block S50, the execution module 150 further switches a permission to operate the diskless workstation 10 from a kernel layer to a user layer. The kernel layer is the most low-level layer in the operating system, which takes care of the communication with the hardware (e.g., memory, CPU). The user layer is the top-level layer in the operating system, which a user can directly operate the operating system. For example, a user interface is provided for the user to operate the operating system in the user layer.

In block S60, the creating module 150 creates a subdirectory in the created temporary directory and a record file in the subdirectory for recording information generated during the running of the operating system. The information includes a log (e.g., time, date, error information) of the operating system. The creating module 150 creates the subdirectory in the created temporary file directory and the record file in the user interface as in one exemplary example as follows:

mkdir -p/var/run/netreport;
mkdir -p/var/lock/subsys;
mkdir -p/var/empty/sshd/etc;
mkdir -p/var/{spool,lib,log};
touch/var/lib/random-seed;
touch/var/log/{dmesg,wtmp},
touch/var/run/utmp;
touch/var/lock/subsys/{network,portmap,netfs,pcscd,autofs,crond,local};
where the “mkdir” is the command for creating directory, the “touch” is a command for creating the file.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A diskless workstation, comprising:
a memory;
at least one processor; and
a resource conflict avoidance unit being executable by the at least one processor, the resource conflict avoidance unit comprising:
a sending module operable to send broadcasting packets to communicate with a server;
a downloading module operable to download a boot program, a kernel, an image file, and a configuration file of an operating system from the server to a memory of the diskless workstation;
an execution module operable to execute the boot program to start the kernel according to the image file and the configuration file, and create a temporary file directory in the memory of the diskless workstation;
a mounting module operable to mount a file system of the operating system in the server to a root directory of the operating system, and mount the created temporary file directory to a default temporary file directory of the root directory; and
a creating module operable to create a subdirectory in the created temporary directory and a record file in the subdirectory for recording information generated during the running of the operating system.

2. The diskless workstation of claim 1, wherein the broadcasting packets comprise an IP address assigned to the diskless workstation by the server.

3. The diskless workstation of claim 1, wherein the boot program is a boot loader of the LINUX operating system, the image file is an initrd file of the LINUX operating system and the configuration file includes a name of the kernel, a position of the kernel, a name of the image file, a position of the image file and parameters for starting the kernel.

4. The diskless workstation of claim 1, wherein the kernel is started by executing the boot loader to invoke the configuration file and the intrid file.

5. The diskless workstation of claim 1, wherein the execution module further switches a permission to operate the diskless workstation from a kernel layer to a user layer.

6. The diskless workstation of claim 1, wherein the creating module creates a subdirectory in the created temporary directory and the record file in a user interface.

7. A computer-based resource conflict avoidance method being performed by execution of computer readable program code by a processor of a diskless workstation that transmits data to a server, the method comprising:
sending broadcasting packets to communicate with the server;
downloading a boot program, a kernel, an image file, and a configuration file of an operating system from the server to a memory of the diskless workstation;
executing the boot program to start the kernel according to the image file and the configuration file, and creating a temporary file directory in the memory of the diskless workstation;
mounting a file system of the operating system in the server to a root directory of the operating system, and mounting the created temporary file directory to a default temporary file directory of the root directory; and
creating a subdirectory in the created temporary directory and a record file in the subdirectory for recording information during the running generated of the operating system.

8. The method of claim 7, wherein the broadcasting packets comprise an IP address assigned to the diskless workstation by the server.

9. The method of claim 7, wherein the boot program is a boot loader of the LINUX operating system, the image file is an initrd file of the LINUX operating system and the configuration file includes a name of the kernel, a position of the kernel, a name of the image file, a position of the image file and parameters for starting the kernel.

10. The method of claim 7, wherein the kernel is started by executing the boot loader to invoke the configuration file and the intrid file.

11. The method of claim 7, wherein the executing step further comprises:
switching a permission to operate the diskless workstation from a kernel layer to a user layer.

12. The method of claim 7, wherein the subdirectory in the created temporary directory and the record file are created in a user interface.

13. A non-transitory computer-readable medium having stored thereon instructions that, when executed by a diskless workstation, causing the diskless workstation to perform a resource conflict avoidance method, the method comprising:
sending broadcasting packets to communicate with a server;
downloading a boot program, a kernel, an image file, and a configuration file of an operating system from the server to a memory of the diskless workstation;
executing the boot program to start the kernel according to the image file and the configuration file, and creating a temporary file directory in the memory of the diskless workstation;
mounting a file system of the operating system in the server to a root directory of the operating system, and mounting the created temporary file directory to a default temporary file directory of the root directory; and
creating a subdirectory in the created temporary directory and a record file in the subdirectory for recording information generated during the running of the operating system.

14. The medium of claim 13, wherein the broadcasting packets comprise an IP address assigned to the diskless workstation by the server.

15. The medium of claim 13, wherein the boot program is a boot loader of the LINUX operating system, the image file is an initrd file of the LINUX operating system and the configuration file includes a name of the kernel, a position of the kernel, a name of the image file, a position of the image file and parameters for starting the kernel.

16. The medium of claim 13, wherein the kernel is started by executing the boot loader to invoke the configuration file and the intrid file.

17. The medium of claim 13, wherein the executing step further comprises:
switching a permission to operate the diskless workstation from a kernel layer to a user layer.

18. The medium of claim 13, wherein the subdirectory in the created temporary directory and the record file are created in a user interface.
